(19) United States
(12) Patent Application Publication
(10) Pub. No.: US 2025/0153697 A1
(43) Pub. Date: May 15, 2025

(54) BRAKE SYSTEM FOR A MOTOR VEHICLE

(71) Applicant: Continental Automotive Technologies GmbH, Hannover (DE)

(72) Inventors: Christian Courth, Frankfurt (DE); Harald Biller, Eschborn (DE); Michael Hitzel, Rödermark (DE)

(73) Assignee: Continental Automotive Technologies GmbH, Hannover (DE)

(21) Appl. No.: 18/720,130

(22) PCT Filed: Dec. 5, 2022
(86) PCT No.: PCT/DE2022/200289

§ 371 Date: Jun. 14, 2024

(30) Foreign Application Priority Data
Dec. 14, 2021 (DE) 10 2021 214 332.6

(51) Int. Cl. B60T 13/68; B60T 13/14; B60T 13/74

(52) U.S. Cl. CPC B60T 13/686; B60T 13/148; B60T 13/745; B60T 2270/402

(57) ABSTRACT

A brake system for a motor vehicle having at least four hydraulically actuable wheel brakes includes a first structural unit (100), in which a first electrically actuable pressure source is arranged, a second structural unit, in which a second electrically actuable pressure source, an electrically actuable inlet valve per wheel brake, and an electrically actuable outlet valve per wheel brake is arranged, and a pressure medium reservoir. The first pressure source and the second pressure source are connected to a brake supply line, to which the at least four inlet valves are connected. The first structural unit and the second structural unit are connected to each other by at most one pressure-resistant hydraulic connecting element.

### CROSS-REFERENCE TO RELATED APPLICATIONS

This application is a national stage application, filed under 35 U.S.C. § 371, of International Patent Application No. PCT/DE2022/200289, filed on Dec. 5, 2022, which claims priority to German patent application No. 10 2021 214 332.6, filed on Dec. 14, 2021, each of which is incorporated by reference.

### TECHNICAL FIELD

The technical field relates to a brake system for a motor vehicle for at least four hydraulically actuable wheel brakes.

### BACKGROUND

A brake system with two electrically controllable pressure sources for a motor vehicle with four hydraulically actuable wheel brakes is known from WO 2018/130483 A1. The brake system comprises not only wheel-individual electrically actuable inlet and outlet valves, but also an electrically actuable circuit isolation valve and at least three further electrically actuable valves. The stated components are arranged together in a single structural unit. Furthermore, two electronic open loop and closed loop control units are provided, wherein one of the electronic open loop and closed loop control units actuates the second pressure source and the inlet and outlet valves, while the first pressure source and all other valves are controlled by the other electronic open loop and closed loop control unit.

DE 10 2018 222 478 A1 discloses a brake system comprising two electrically controllable pressure sources as well as a brake pedal-actuable master brake cylinder, wheel-individual electrically actuable inlet and outlet valves, an electrically actuable circuit isolation valve, an electrically actuable pump valve for the second electrically controllable pressure source and a normally closed switch-on valve for the first electrically controllable pressure source. The second electrically controllable pressure source, the associated pump valve and the inlet and outlet valves are arranged here in a first module, and the master brake cylinder with associated driver's disconnect valve and simulator, the first electrically controllable pressure source, the associated normally closed switch-on valve and the circuit isolation valve are arranged in a second module.

There remains an opportunity to provide an improved brake system suitable for highly automated driving, which in particular provides the highest possible availability necessary for highly automated driving.

There also remains an opportunity to keep the costs for the manufacture and assembly of the brake system as low as possible.

### SUMMARY

In one embodiment, a brake system includes a first structural unit, in which a first electrically actuable pressure source is arranged. The brake system also includes a second structural unit, in which a second electrically actuable pressure source, an electrically actuable inlet valve per wheel brake, and an electrically actuable outlet valve per wheel brake are arranged The brake system further includes a pressure medium reservoir. The first pressure source and the second pressure source are connected to a brake supply line, to which the at least four inlet valves are connected. The first structural unit and the second structural unit are connected to each other by at most one pressure-resistant hydraulic connecting element.

Further non-pressure-resistant connecting elements between the first and second structural unit are possible.

A pressure-resistant connecting element or a pressure-resistant attachment/connection is preferably understood to mean that the connecting element or the attachment/connection is designed for a maximum operating pressure of one of the pressure sources, in particular the first pressure source, and/or the wheel brakes. The pressure-resistant connecting element or the pressure-resistant attachment/connection is may be designed for a pressure of approximately 180-220 bar. The pressure-resistant connecting element or the pressure-resistant attachment/connection may be designed for a pressure of approximately 200 bar.

A non-pressure-resistant connecting element or a non-pressure-resistant attachment/connection is preferably understood to mean that the connecting element or the attachment/connection is not designed for the maximum operating pressure of the wheel brakes. A non-pressure-resistant connecting element or a non-pressure-resistant attachment/connection may be designed for a maximum pressure of approximately 10 bar.

The first structural unit and the second structural unit are designed in such a way that they are connected to each other by at most one pressure-resistant hydraulic connecting element. The first structural unit and the second structural unit may be connected to each other by a plurality of hydraulic connecting elements, but at most one—in the sense of only one—of these hydraulic connecting elements is of pressure-resistant configuration, namely the pressure-resistant hydraulic connecting element. Any other hydraulic connecting elements are not of pressure-resistant configuration.

The first structural unit and the second structural unit may be connected to each other by merely one hydraulic connecting element, wherein this connecting element is of pressure-resistant configuration, i.e., is the pressure-resistant hydraulic connecting element. Further, non-pressure-resistant elements, advantageously between the second structural unit and the pressure medium reservoir, are possible.

The pressure medium reservoir may be arranged on the first structural unit.

The pressure medium reservoir may be under atmospheric pressure.

The brake system includes one inlet valve and one outlet valve per wheel brake. For each wheel brake, the inlet valve may be arranged hydraulically between the brake supply line and the assigned wheel brake and the outlet valve is arranged hydraulically between the assigned wheel brake and the pressure medium reservoir. The inlet and outlet valves are used to adjust wheel-individual brake pressures as required, which are derived from the brake supply pressure in the brake supply line.

The inlet valves may forward the brake supply pressure to the wheel brakes in the non-actuated state (i.e., preferably normally open inlet valves), the outlet valves block a flow of pressure medium from the wheel brakes in the non-actuated state (i.e., preferably normally closed inlet valves).

The outlet valves may be connected via a common hydraulic connection (so-called return line) to the pressure medium reservoir. The second pressure source may be connected hydraulically by way of its suction connection (suction side or, if applicable, its suction sides) to the return line. Thus, a single non-pressure-resistant connecting element between the second structural unit and the pressure medium reservoir is possible.

The first pressure source may be connected to the brake supply line via an electrically actuable, first isolation valve, wherein the first isolation valve is arranged in the second structural unit. The first isolating valve may be of normally open configuration. By closing the first isolation valve, e.g., in the event of a leak in the first structural unit, a flow of pressure medium from the second structural unit via the pressure-resistant hydraulic connecting element into the first structural unit can be prevented. The first structural unit can also be hydraulically separated from the brake supply line by means of the first isolation valve, e.g., if the brake system is to be or has to be operated in a mode of operation (e.g., in the event of an electrical failure of the first structural unit), in which the at least four wheel brakes are pressurized by means of the second pressure source.

Alternatively, the first isolation valve may be arranged in the first structural unit and is of normally closed configuration. In the event of a leak in the first pressure source, closing the first isolation valve can thus prevent pressure medium from flowing out of the first pressure source.

Alternatively, the first pressure source may be connected to the brake supply line without an electrically actuable valve being connected in between.

A check valve opening in the direction of the brake supply line may be connected in parallel to the first isolation valve, wherein the check valve is advantageously arranged in the second structural unit.

In addition, or alternatively, an electrically actuable, in particular normally closed, third isolation valve is connected in parallel to the first isolation valve, wherein the third isolation valve is arranged in the second structural unit.

Furthermore, the first pressure source may be connected to the pressure medium reservoir via an electrically actuable second isolation valve, wherein the second isolation valve is arranged in the first structural unit. The second isolating valve may be of normally open configuration. For example, when the brake system is de-energized, the second isolation valve allows pressure fluid to flow from the wheel brakes into the pressure medium reservoir, which is advantageous for ensuring the wheel brakes are depressurized (reducing residual braking torques), e.g., when the vehicle is parked.

A check valve opening in the direction of the first pressure source may be connected in parallel to the second isolation valve.

In addition, the first pressure source may be connected, in particular for replenishing pressure medium, via a check valve opening in the direction of the first pressure source to the pressure medium reservoir.

An electrically actuable circuit isolation valve may be arranged in the brake supply line such that, when the circuit isolation valve is closed, the brake supply line is hydraulically separated into a first line section and a second line section. Here, the first line section is hydraulically connected to the second pressure source and at least two of the at least four inlet valves, or the first line section connects the second pressure source to at least two of the at least four inlet valves hydraulically. Furthermore, the second line section is connected to the first pressure source and the others, in particular at least two, of the at least four inlet valves hydraulically, or the second line section connects the first pressure source to the others, in particular at least two, of the at least four inlet valves hydraulically. The circuit isolation valve is arranged in the second structural unit here. The circuit isolation valve can be used to separate or divide the brake system into two brake circuits. Here, in the one (first) brake circuit, the second pressure source is hydraulically connected to the at least two of the at least four inlet valves, and in the other (second) brake circuit, the first pressure source is hydraulically connected to the other inlet valves of the at least four inlet valves. In a combined operating mode, the wheel brakes, which are assigned to the first brake circuit, can thus be actuated by means of the second pressure source, while the wheel brakes, which are assigned to the second brake circuit, are actuated by means of the first pressure source.

The circuit isolation valve may be of normally open configuration, with the result that in normal braking mode, when the at least four wheel brakes are pressurized by means of the first pressure source, or else in one operating mode, when the at least four wheel brakes are pressurized by means of the second pressure source, no actuation of the circuit isolation valve is necessary. This reduces the power consumption of the brake system and avoids potentially disturbing valve switching noises.

The first structural unit may include at least one first hydraulic connection for connection to the pressure medium reservoir and a second hydraulic connection for connection to the second structural unit, wherein the second hydraulic connection is connected to the pressure-resistant hydraulic connecting element. Accordingly, the second hydraulic connection must be configured for a pressure-resistant connection. The first hydraulic connection must only be designed for a pressure-free (atmospheric) or non-pressure-resistant attachment.

The first structural unit includes, in addition to the first and the second hydraulic connection, no further hydraulic connection.

Particularly preferably, the first pressure source, in particular for replenishment of pressure means, in particular via a check valve opening in the direction of the first pressure source, is connected to the first hydraulic connection, and the first pressure source is, in particular for actuating the at least four wheel brakes, connected to the second hydraulic connection.

According to one embodiment, the second structural unit includes at least four hydraulic wheel connections for connecting to the wheel brakes, a first hydraulic connection for connecting to the pressure medium reservoir and a second hydraulic connection for connecting to the first structural unit, wherein the second hydraulic connection is connected to the pressure-resistant hydraulic connecting element. Accordingly, the second hydraulic connection of the second structural unit is configured for a pressure-resistant connection. For actuation of the wheel brakes, the wheel connections of the second structural unit are also configured for a pressure-resistant connection, whereas the first hydraulic connection of the second structural unit must only be designed for a pressure-free (atmospheric) or non-pressure-resistant attachment.

Preferably, the second structural unit does not include any further hydraulic connection in addition to the wheel connections and the first (non-pressure-resistant) and the second (pressure-resistant) connection.

According to one embodiment, the first hydraulic connection of the first structural unit and the first hydraulic connection of the second structural unit are connected to different chambers of the pressure medium reservoir. Thus, an (at least partial) separation of the pressure medium supplies for the first structural unit or first pressure source as well as the second structural unit or second pressure source is ensured. This achieves an increased availability of the brake system in the event of a leak.

Preferably, the second pressure source is connected to the pressure medium reservoir on the suction side without intermediate connection of an electrically actuable valve. In this way, the lowest possible suction resistance for the second pressure source can be achieved.

The second pressure source may be connected on the suction side to the pressure medium reservoir without intermediate connection of an electrically actuable valve, via the first hydraulic connection of the second structural unit and a hydraulic connecting line connected to the first hydraulic connection. In this embodiment, the hydraulic connecting line does not pass through the first structural unit. The hydraulic connecting line between the second structural unit and the pressure medium reservoir does not need to be of pressure-resistant configuration. The hydraulic connecting line between the second structural unit and the pressure medium reservoir advantageously has a greater diameter than the pressure-resistant hydraulic connecting element between the first and second structural unit.

The second pressure source may be connected to the pressure medium reservoir on the suction side without an intermediate connection of a valve.

In addition to the first and the second electrically actuable pressure source, the brake system may not include a further pressure source for building up a brake pressure for actuating the wheel brakes. Particularly, the brake system includes neither a further electrically actuable pressure source nor a driver-actuable pressure source, such as a master brake cylinder, which is operatively connected to at least one of the wheel brakes for their actuation, e.g., hydraulically or mechanically connected.

According to one embodiment, the brake system includes a first electronic control device, which is assigned to the first structural unit, is particularly preferably part of the first structural unit, and which actuates the electrical components arranged in the first structural unit (e.g., the first pressure source and the second isolation valve). The brake system may also include a second electronic control device, which is assigned to the second structural unit, particularly preferably is part of the second structural unit, and which actuates the electrical components arranged in the second structural unit (e.g., the second pressure source, the inlet and outlet valves, the first isolation valve and the circuit isolation valve).

According to one embodiment, the first structural unit includes a first electronic control device, which actuates the first pressure source.

The second isolation valve may be actuated by the first electronic control device. Thus, the second isolation valve can be closed by means of the first electronic control device, when the first pressure source is actuated by means of the first electronic control device, in order to build up a brake pressure in the second structural unit via the only pressure-resistant hydraulic connecting element between the first and second structural unit.

The second structural unit may include a second electronic control device, which actuates the second pressure source and the inlet and outlet valves.

The circuit isolation valve may be actuated by the second electronic control device. Thus, in the event of a leak in the second brake circuit of the second structural unit, the two brake circuits can be separated by means of the second electronic control device and the second electronic control device can build up a pressure by means of the second pressure source in at least the first brake circuit or the wheel brakes associated with the first brake circuit.

The first isolation valve may be actuated by the second electronic control device. Thus, by means of the second electronic control device, for example in the case of a leak in the first structural unit or in the case of a failure of the first electronic control device, the first isolation valve can be closed and a flow of pressure medium from the brake supply line into the first structural unit can be prevented.

The brake system may include a first electrical partition and a second electrical partition, which are electrically independent of each other, wherein the first pressure source and the first electronic control device are assigned to the first electrical partition, and wherein the second pressure source, the second electronic control device and the inlet and outlet valves are assigned to the second electrical partition.

The circuit isolation valve may be assigned to the second electrical partition.

The first isolation valve may be assigned to the second electrical partition.

The second isolation valve may be assigned to the first electrical partition.

The first pressure source may be actuated exclusively by the first electronic control device, and the second pressure source and the inlet and outlet valves, and in particular the circuit isolation valve, are actuated exclusively by the second electronic control device.

Preferably, the second isolation valve is actuated exclusively by the first electronic control device.

Preferably, the first isolation valve is actuated exclusively by the second electronic control device.

Particularly preferably, the third isolation valve is actuated, in particular exclusively, by the second electronic control device.

According to one embodiment, the first pressure source is formed by a cylinder-piston arrangement with a hydraulic pressure chamber, the piston of which is driven forward by an electromechanical actuator for a brake pressure build-up and backward for a brake pressure reduction.

The first pressure source may be formed by a cylinder-piston arrangement with a hydraulic pressure chamber, a suction connection and a pressure connection, the piston of which is moved forward and backward by an electromechanical actuator. The suction connection may be hydraulically connected to the pressure medium reservoir via a check valve opening in the direction of the pressure chamber. The pressure connection may be hydraulically connected to the pressure medium reservoir via a second isolation valve. The pressure connection may be hydraulically connected via a first isolation valve to the brake supply line, in particular to the second line section of the brake supply line.

Alternatively, the first pressure source is formed by a cylinder-piston arrangement with a hydraulic pressure chamber, a suction connection, a pressure connection and a snifter hole, the piston of which is moved forward and backward by an electromechanical actuator. The suction connection may be hydraulically connected to the pressure medium reservoir via a check valve opening in the direction of the pressure chamber. The snifter hole may be hydraulically connected to the pressure medium reservoir. In the case of a cylinder-piston arrangement with a snifter hole, no connection between the pressure connection and the pressure medium reservoir with a second isolation valve is required or provided. The pressure connection may be hydraulically connected via a first isolation valve to the brake supply line, in particular to the second line section of the brake supply line.

Alternatively, the first pressure source may be formed by a cylinder-piston arrangement with a hydraulic pressure chamber and a pressure connection, the piston of which is moved forward and backward by an electromechanical actuator. The pressure connection may be hydraulically connected to the pressure medium reservoir via a check valve opening in the direction of the pressure chamber. The pressure connection may be hydraulically connected to the pressure medium reservoir via a second isolation valve. The pressure connection may be hydraulically connected via a first isolation valve to the brake supply line, in particular to the second line section of the brake supply line.

The first pressure source may include a pressure connection, which is hydraulically connected to the pressure medium reservoir via an electrically actuable, advantageously normally open, second isolation valve. The pressure connection of the first pressure source may be hydraulically connected to a suction connection of the first pressure source via the electrically actuable second isolation valve.

The second isolation valve may be arranged in the first structural unit.

Preferably, the second isolation valve is actuated by an electronic control device (first electronic control device) associated with the first structural unit.

According to one embodiment, the second pressure source is configured with two or more circuits. The second pressure source may be configured as a two-piston pump or multi-piston pump.

According to a first embodiment, the pressure sides of the pressure source with two or more circuits are interconnected to form a common pressure connection, and the suction sides of the pressure source with two or more circuits are interconnected to form a common suction connection. The suction connection (and thus the suction sides) is particularly preferably connected to the pressure medium reservoir, in particular to the return line of the outlet valves. The pressure connection (and thus the pressure sides) is particularly preferably connected to the brake supply line, very particularly preferably to the first line section of the brake supply line.

According to a second, alternative embodiment, the suction sides of the pressure source with two or more circuits are interconnected to form a common suction connection, while the pressure sides of the pressure source with two or more circuits are not interconnected, with the result that a first and a second pressure connection are provided. The suction connection (and thus the suction sides) is particularly preferably connected to the pressure medium reservoir, in particular to the return line of the outlet valves. One of the pressure sides (one of the pressure connections) is particularly preferably connected to the first line section of the brake supply line, and the other pressure side (the other pressure connection) is particularly preferably connected to the second line section of the brake supply line.

According to a further embodiment, the brake system includes an actuating unit for a vehicle driver, wherein the actuating unit is connected to at least one of the two electronic control devices for transmitting a driver's desired signal, and wherein there is no mechanical-hydraulic connection from the actuating unit to the wheel brakes.

The actuating unit may include a first sensor for detecting a braking request of the driver and a second sensor for detecting a braking request of the vehicle driver, which is independent of the first sensor. The first sensor may be assigned to one of the two electrical partitions and the second sensor is assigned to the other of the two electrical partitions.

The first sensor may be connected to one of the two electronic control devices on the signal side and the second sensor is connected to the other of the two electronic control devices on the signal side.

The first electronic control device or the first electrical partition may be supplied by a first electrical energy source and the second electronic control device or the second electrical partition may be supplied by a second electrical energy source, which is independent of the first electrical energy source. The first energy source is thus part of the first electrical partition, and the second energy source is part of the second electrical partition.

The brake system described herein offers the advantage that the number of electrically actuable valves is small. Furthermore, it offers the advantage that the number of hydraulic connections, in particular the hydraulic connections between the components or structural units of the brake system, are small. This means that the brake system can be manufactured and assembled cost-effectively.

A division into two structural units offers the advantage that both structural units are each smaller and lighter and therefore easier to handle compared to a single structural unit. They can also be manufactured more easily on existing production equipment. On the other hand, when divided into two structural units, each hydraulic connection between these structural units leads to considerable complexity and costs. It is therefore particularly advantageous to keep the number of hydraulic connections as small as possible. It has been shown that it is advantageous to separate the various functions of hydraulic connections as clearly as possible. This means that connections, through which pressure medium is drawn in, can be configured with the largest possible diameter, so that they have the smallest possible hydraulic resistance. For this purpose, it is advantageous if it is achieved that such connections do not have to be pressure-resistant. Conversely, pressure-bearing connections should not have a suction function.

The brake system described herein also offers the advantage that a clear separation of the properties of the hydraulic connections is made possible by the selection and arrangement of the electrically actuable valves in the structural units, the associated electronic partitioning and in particular the assignment between electrically actuable valves and electronic control devices.

The brake system can maintain the most important residual braking functions even in the event of failure of one of the two redundant electrical pressure sources, e.g., due to a failure of the associated electrical energy source or the associated electronic control device or a mechanical fault or a leak in the pressure source itself.

The brake system is therefore particularly suitable for the realization of highly automated driving functions.

### BRIEF DESCRIPTION OF THE DRAWINGS

Further embodiments of the invention are derived from the dependent claims and the following description with reference to figures, in which, schematically:

FIG. 1 shows a first exemplary embodiment of a brake system,

FIG. 2 shows a second exemplary embodiment of the brake system,

FIG. 3 shows a third exemplary embodiment of the brake system,

FIG. 4 shows a fourth exemplary embodiment of the brake system,

FIG. 5 shows a fifth exemplary embodiment of the brake system,

FIG. 6 shows a further exemplary embodiment of the brake system,

FIG. 7 shows a further exemplary embodiment of the brake system, and

FIG. 8 shows a further exemplary embodiment of the brake system.

### DETAILED DESCRIPTION

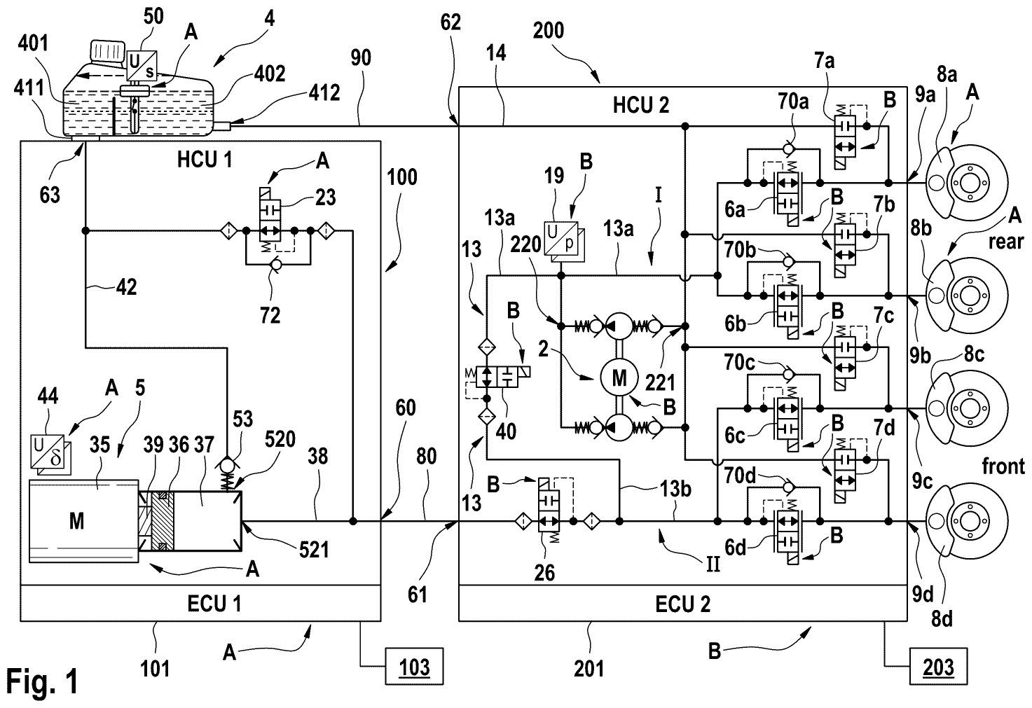

FIG. 1 shows a first exemplary embodiment of a brake system for a motor vehicle in a highly schematic manner. According to the example, the brake system is configured for actuating four hydraulically actuable wheel brakes 8a-8d; an extension to more wheel brakes is simply possible. According to the example, the wheel brakes 8a, 8b are assigned to the rear axle (rear) and the wheel brakes 8c, 8d are assigned to the front axle (front) of the vehicle.

The brake system includes a first structural unit 100, which is configured, for example, as a first electro-hydraulic brake control unit (HECU1) with a valve block HCU1 and a first electronic control device 101 (ECU1), a second structural unit 200, which, according to the example, is configured as a second electro-hydraulic brake control unit (HECU2) with a valve block HCU2 and a second electronic control device 201 (ECU2), and a pressure medium reservoir 4.

The pressure medium reservoir 4, which is under atmospheric pressure, is advantageously arranged on the first structural unit 100. The pressure medium reservoir 4 comprises, according to the example, two chambers, wherein the first chamber 401 is assigned a first container connection 411 and the second chamber 402 is assigned a second container connection 412.

A first electrically actuable pressure source 5 is arranged in the first structural unit 100.

A second electrically actuable pressure source 2 and wheel-individual brake pressure modulation valves are arranged in the second structural unit 200 and are designed as an electrically actuable inlet valve 6a-6d per wheel brake 8a-8d and an electrically actuable outlet valve 7a-7d per wheel brake 8a-8d.

The first pressure source 5 and the second pressure source 2 are connected on the pressure side to a brake supply line 13, to which the four inlet valves 6a-6d are connected. Thus, all four wheel brakes 8a-8d can be actuated by the first pressure source 5 or by the second pressure source 2.

An electrically actuable circuit isolation valve 40 is arranged in the brake supply line 13, so that when the circuit isolation valve 40 is closed, the brake supply line 13 is divided into a first line section 13a, to which the inlet valves 6a, 6b and the wheel brakes 8a, 8b are connected, and a second line section 13b, to which the inlet valves 6c, 6d and the wheel brakes 8c, 8d are connected. The second pressure source 2 is hydraulically connected to the first line section 13a, and the first pressure source 5 is hydraulically connected to the second line section 13b. With the circuit isolation valve 40 closed, the brake system is thus separated or divided into two hydraulic brake circuits I and II. In the first brake circuit I, the pressure source 2 is connected (via the first line section 13a) to only the wheel brakes 8a and 8b, and in the second brake circuit II, the first pressure source 5 is connected (via the second line section 13b) to only the wheel brakes 8c and 8d. The circuit isolation valve 40 is advantageously of normally open configuration.

The brake system includes, as already mentioned, for each hydraulically actuable wheel brake 8a-8d, an inlet valve 6a-6d and an outlet valve 7a-7d, which are hydraulically interconnected in pairs via center connections and are each connected to a hydraulic wheel connection 9a-9d of the second structural unit 200, to which the corresponding wheel brake 8a-8d is connected. A check valve 70a-70d opening to the brake supply line 13 is connected in each case in parallel to the inlet valves 6a-6d. The output connections of the outlet valves 7a-7d are connected via a common return line 14 to a hydraulic connection 62 of the second structural unit 200, which is connected to the pressure medium reservoir 4, according to the example to its second container connection 412 or to its chamber 402. The input connections of all inlet valves 6a-6d can be supplied by means of the brake supply line 13 (i.e. with an open circuit isolation valve 40) with a pressure which is provided by the first pressure source 5 or, e.g. in case of failure of the first pressure source 5, by the second pressure source 2.

The second electrically controllable pressure source 2 of the second structural unit 200 includes a pressure connection 220, which is hydraulically connected to the first line section 13a, and a suction connection 221, which is hydraulically connected to the pressure medium reservoir 4, according to the example via a return line 14 and connection 62. The connection 62, and thus the suction connection (the suction side(s)) 221 of the pressure source 2, is directly connected to the pressure medium reservoir 4 via a line or a hose 90. This connection 90 does not bear pressure and can therefore have a large diameter.

According to the example, the connection 62 is hydraulically connected by means of the connecting line/connecting hose 90 to the second container connection 412 (and thus the second chamber 402) of the pressure medium reservoir 4.

The first electrically controllable pressure source 5 of the first structural unit 100 (or the valve block HCU1) is configured as a hydraulic cylinder-piston arrangement (or a single-circuit electro-hydraulic actuator (linear actuator)), the piston 36 of which can be actuated by a schematically indicated electric motor 35 with an intermediate connection a likewise of schematically illustrated rotational/translational gear mechanism 39, and, in particular, can be moved forward and backward to build up and reduce a pressure in a pressure chamber 37. The piston 36 delimits the pressure chamber 37 of the pressure source 5. For the actuation of the electric motor, a rotor position sensor 44 is provided, which detects the rotor position of the electric motor 35 and which is merely schematically indicated.

A system pressure line section 38 is connected to the pressure chamber 37 of the first electrically controllable pressure source 5. By means of the line section 38, the pressure source 5 or its pressure chamber 37 is hydraulically connected to a hydraulic connection 60 of the first structural unit 100, which is hydraulically connected via a hydraulic connecting element 80 to a hydraulic (pressure) connection 61 of the second structural unit 200. The connection 80 is the only hydraulic pressure connection, in particular the only hydraulic connection, between the first structural unit 100 and the second structural unit 200. It is a hydraulic connection for transmitting a brake pressure to actuate the wheel brakes 8a-8d (hence pressure connection). The connection element 80 must therefore be of pressure-resistant configuration, e.g. as a pressure-resistant brake hose.

The pressure chamber 37 is, according to the example, hydraulically connected to a hydraulic connection 63 of the first structural unit 100 via a (replenishing) line 42 configured in the first structural unit 100, independently of the actuating state of the piston 36. The connection 63 is hydraulically connected to the pressure medium reservoir 4, according to the example to its first container connection 411 and thus its first chamber 401. A check valve 53 closing in the direction of the pressure medium reservoir 4 is arranged in the (replenishing) line 42. The exemplary pressure source/cylinder-piston arrangement 5, for example, has no snifter holes.

Furthermore, the pressure chamber 37 is hydraulically connected to the hydraulic connection 63 (and the (replenishing) line 42)), according to the example, via the line section 38 and an electrically actuable, second isolation valve 23 which is advantageously of normally open configuration. According to the example, a check valve 72 opening in the direction of the pressure chamber 37 is connected in parallel to the second isolation valve 23.

In addition to the (pressure medium reservoir) connection 63 and the (pressure) connection 60, the first structural unit 100 does not, according to the example, include any other hydraulic connection.

The second electrically controllable pressure source 2 of the second structural unit 200 is configured, according to the example, as a two-piston pump, the two pressure sides of which are interconnected (to the pressure connection 220) and the two suction sides of which are interconnected (to the suction connection 221). The suction connection 221 (and thus the two suction sides) of the pressure source 2 is hydraulically connected to the return line 14 and thus to the connection 62 or the pressure medium reservoir 4. The pressure connection 220 (and thus the two pressure sides) of the pressure source 2 are connected to the first line section 13a of the brake supply line 13.

In addition to the pressure source 2 and the brake pressure modulation valves 6a-6d, 7a-7d, an electrically actuable isolation valve 26 which is advantageously of normally open configuration is preferably arranged in the second structural unit 200. The isolation valve 26 is hydraulically arranged between the connection 61 and the second line section 13b of the brake supply line 13. Thus, the first pressure source 5 is separably connected to the second line section 13b or the brake supply line 13 via the isolation valve 26.

The brake system includes, according to the example, in the brake circuit I (line section 13a), a pressure sensor 19, which is thus assigned to the second pressure source 2. This is advantageous for protection against bursting in the case of active circuit disconnection, i.e. when the circuit isolation valve 40 is closed. However, the pressure sensor 19 may also be arranged in the brake circuit II, or a second pressure sensor may be provided, with the result that each of the two brake circuits I and II can be directly monitored by means of a pressure sensor.

According to the example, the brake system includes, for leakage monitoring purposes, a level-measuring device 50 for determining a pressure medium level in the pressure medium reservoir 4.

According to the example, the components 5, 53, 23, 72 and the line sections 38, 42 are arranged in the first valve block HCU1, and the components 2, 6a-6d, 7a-7d, 26, 19 and the line sections 13a, 13b (and the line sections between the inlet and outlet valves firstly and the wheel connections secondly) are arranged in the second valve block HCU2.

An electronic control device 101, 201 (ECU1, ECU2) is assigned to each valve block HCU1, HCU2. Each electronic control device 101, 201 comprises electrical and/or electronic elements (e.g., microcontrollers, power modules, valve drivers, other electronic components, etc.) for actuating the electrically actuable components of the associated valve block (structural unit) and, if necessary, for evaluating the signals of the sensors assigned to this valve block (structural unit). The valve block and electronic control device are advantageously configured in what is known as an electro-hydraulic unit (HECU).

For the electrical attachment, connection and supply of the individual components of the brake system which are electrical or electrically actuable, activatable, evaluable or the like, a first electrical partition A and a second electrical partition B are provided, which are electrically independent of one another.

In the figures, those electrical components which are assigned or belong to the first electrical partition A are indicated by an arrow A, while those electrical components which are assigned or belong to the second electrical partition B are indicated by an arrow B.

The electronic control device 101 is assigned to or belongs to the first electrical partition A, while the second electronic control device 201 is assigned to or belongs to the second electrical partition B. Accordingly, the electronic control device 101 and the second electronic control device 201 are electrically independent.

To supply the brake system with electrical energy, a first electrical energy source 103, for example a vehicle electrical system, and a second electrical energy source 203, for example a vehicle electrical system, which is independent of the first energy source are provided. The first electrical energy source 103 supplies the first electrical partition A with energy, and the second electrical energy source 203 supplies the second electrical partition B.

The first electronic control device 101 actuates the first pressure source 5. Accordingly, the first pressure source 5 is assigned to or associated with the first electrical partition A. According to the example, the first pressure source 5 is supplied with energy (from the first electrical energy source 103) via the first electronic control device 101.

The second electronic control device 201 actuates the second pressure source 2. Accordingly, the second pressure source 2 is assigned to or associated with the second electrical partition B. According to the example, the second pressure source 2 is supplied with energy (from the second electrical energy source 203) via the second electronic control device 201.

According to the example, the first pressure source 5 can be or is actuated exclusively by the first electronic control device 101 and the second pressure source 2 exclusively by the second electronic control device 201. Fundamentally, it would be conceivable to equip the electric motor of a pressure source, for example, with two electrically independent motor windings; the pressure source could thus be actuated by the two independent electrical devices. This would, however, be associated with further redundancies, for example double connecting lines etc., and would thus be more expensive.

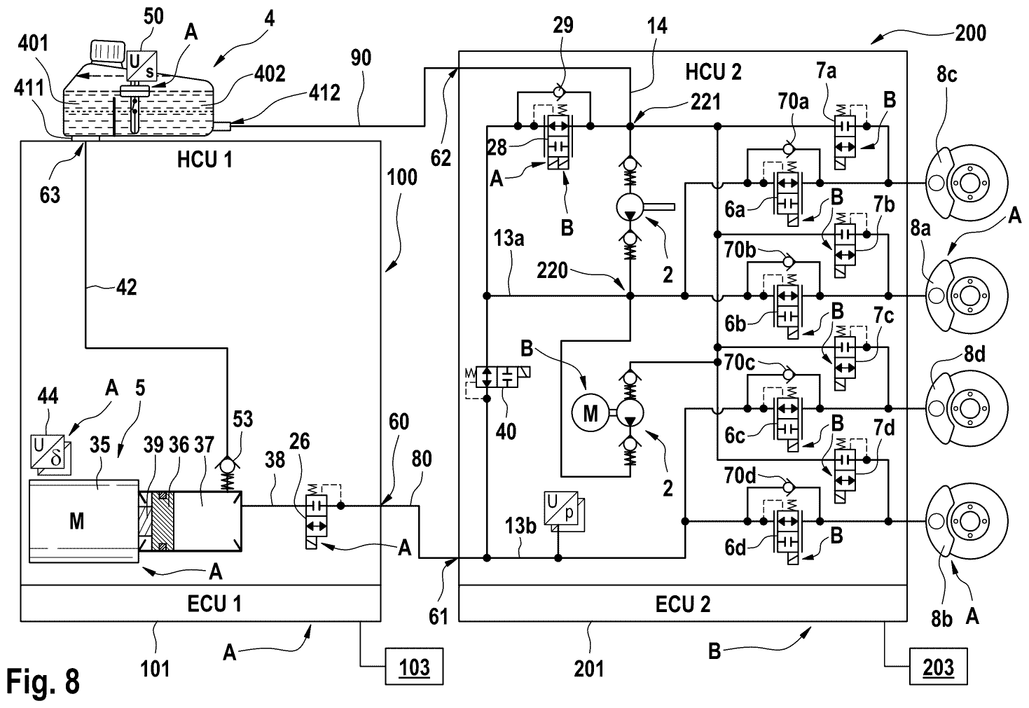

The remaining components of the brake system are advantageously assigned to either the first electronic control device 101 (partition A) or the second electronic control device 201 (partition B). That is to say, they are actuated or activated and/or supplied with electrical energy by this control device and/or are connected to this control device on the signal side and/or are evaluated by this control device. In order to avoid further redundancies, a component is advantageously actuable or activatable or supplied with electrical energy or connected on the signal side or evaluable only or exclusively by one of the two electronic control devices 101, 201, but not by the other electronic control device (exception: see exemplary embodiment of FIG. 8 with a double actuable valve 28).

The inlet and outlet valves 6a-6d, 7a-7d are assigned to the second electrical partition B and are actuated by the second electronic control device 201. Likewise, the circuit isolation valve 40 is assigned to the second electrical partition B and is actuated by the second electronic control device 201.

The isolation valve 26 for the separation of the first pressure source 5 and brake supply line 13 is also assigned, according to the example, to the second electrical partition B and is actuated by the second electronic control device 201.

The pressure sensor 19 is likewise assigned to the second electrical partition B. Its signals are fed to the second electronic control device 201 and evaluated and processed by the latter.

The isolation valve 23 is assigned to the first electrical partition A and is actuated by the first electronic control device 101.

Furthermore, the signals of the level-measuring device 50 are supplied to the first electronic control device 101 and evaluated and processed by the latter.

The brake system may include electrically actuable parking brakes on the rear wheels (rear). These are advantageously activated and actuated by the first electronic control device 101, labeled by A at the wheel brakes 8a, 8b in FIG. 1.

The brake system according to the example has a primary pressure source 5 and a secondary pressure source 2, each of which is electrically operated by an ECU (Electronic Control Unit) and has a suction connection and a pressure connection. No brake fluid can flow into the pressure connection 220 of the secondary pressure source 2 even when the system is de-energized. The primary pressure source 5 may be a linear actuator with a replenishing check valve 53, and the secondary pressure source 2 may be a piston pump. The secondary pressure source 2 may generate a higher pressure than the primary pressure source 5.

The suction connections 221 and 520 of the two pressure sources 2 and 5, respectively, are connected to a pressure medium reservoir 4, preferably each to one of two separate chambers (402, 401).

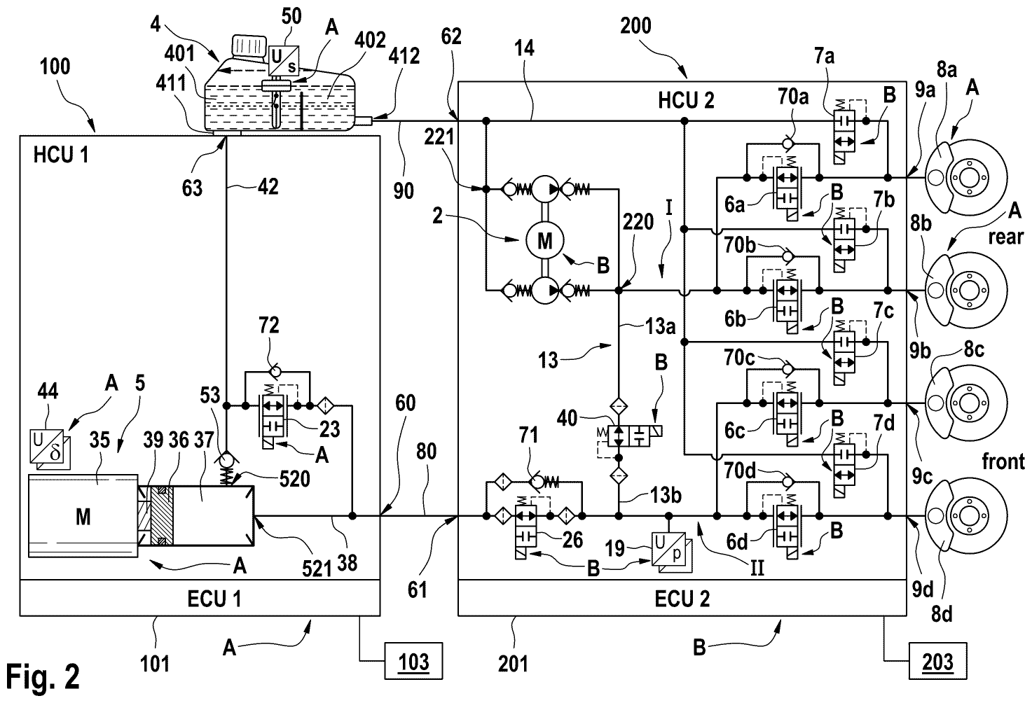

The pressure connection 521 of the primary pressure source 5 is connected to a primary circuit node (second line section 13b) via an electromagnetic valve 26, also called a pressure switch-on valve. A check valve 71 can be connected in parallel to the valve 26 (see e.g. FIG. 2), which allows a volumetric flow from the primary pressure source 5 to the primary circuit node (13b).

The pressure connection 220 of the secondary pressure source 2 is connected directly (without intermediate connection of a valve) to a secondary circuit node (first line section 13a).

The two circuit nodes (line sections 13a, 13b) are connected to each other via an electromagnetic valve 40, also called a circuit isolation valve.

The two circuit nodes are connected to wheel brakes 8a-8d via electromagnetic inlet valves 6a-6d; according to the example, the primary circuit node (13b) is connected to the wheel brakes 8c, 8d of the front axle, and the secondary circuit node (13a) is connected to the wheel brakes 8a, 8b of the rear axle.

The wheel brakes 8a-8d are connected to the pressure medium reservoir 4 via electromagnetic outlet valves 7a-7d.

The output connection 521 of the primary pressure source 5 is connected to the pressure medium reservoir 4 via an electromagnetic valve 23, also called a pressure relief valve.

The valve 26, valve 40, and valve 23 may be of normally open configuration.

In normal braking mode, the pressure in the wheel brakes 8a-8d is built up by the primary pressure source 5 with the isolation valve 23 closed. The pressure is dissipated into the primary pressure source 5 (retraction of the piston 36) or into the pressure medium reservoir 4 via the isolation valve 23.

The wheel brake pressure is modulated by the inlet and outlet valves 6a-6d, 7a-7d on a wheel-by-wheel basis if required (e.g., in the case of an anti-lock braking control operation or other brake control function). If necessary, the isolation valve 26 is closed so that the primary pressure source 5 can replenish additional volume from the pressure medium reservoir 4.

If a particularly high volumetric flow is required or requested, both pressure sources 5 and 2 preferably operate simultaneously in parallel. In this case, the pressure is reduced at least partially via the isolation valve 23, which may be configured as an analog valve, i.e., can control its flow. If a particularly high pressure is requested, the isolation valve 26 is preferably closed and the secondary pressure source 2 increases the pressure beyond the pressure of the primary pressure source 5.

Outside of braking operations, atmospheric pressure equalization is permanently ensured via the isolation valve 23 and isolation valve 26.

In the event of a leak in the brake system, the circuit isolation valve 40 is preferably closed and the system is thus divided into two independent brake circuits I and II.

The isolation valve 23 may be actuated by the primary ECU 101. The isolation valve 26 may be actuated by the secondary ECU 201. The following description of operation in the event of a fault refers to this valve assignment.

If the primary system (structural unit 100) fails electrically, in particular the primary ECU 101 or its power supply 103 (partition A failure), the secondary ECU 201 closes the isolation valve 26 to build up pressure via the secondary pressure source 2. Pressure is reduced via the isolation valve 26 or via the outlet valves 7a-7d. Preferably, the inlet and outlet valves are actuated by the secondary ECU 201 (partition B), with the result that the pressure can be modulated in a wheel-individual manner.

If the secondary system (structural unit 200) fails electrically, in particular the secondary ECU 201 or its power supply 203 (partition B failure), the pressure is built up and released as in normal operation via the primary pressure source 5 and, if necessary, the isolation valve 23. There is no need for wheel-individual pressure control, but a common modulation of the wheel pressures remains possible to prevent the vehicle from being destabilized by locking wheels.

Preferably, the allocation of the valves to the two ECUs is as described above; the circuit isolation valve 40 is actuated by the secondary ECU 201, and the system is divided into two structural units 100 and 200 with two hydraulic connecting lines, namely the pressure-resistant connecting element 80 and the pressure-free or non-pressure-resistant connecting line 90. These two structural units 100, 200 may each comprise one of the two ECUs, the assigned pressure source and the assigned valves.

FIG. 2 schematically illustrates a second exemplary embodiment of a brake system. In contrast to the first exemplary embodiment of FIG. 1, a check valve 71 is connected in parallel to the isolation valve 26 of the second structural unit 200, which allows a volumetric flow from the primary pressure source 5 to the line section 13b, in order to reduce the hydraulic resistance of the valve 26 in the pressure build-up direction. Furthermore, the pressure sensor 19 is arranged on the line section 13b (brake circuit II).

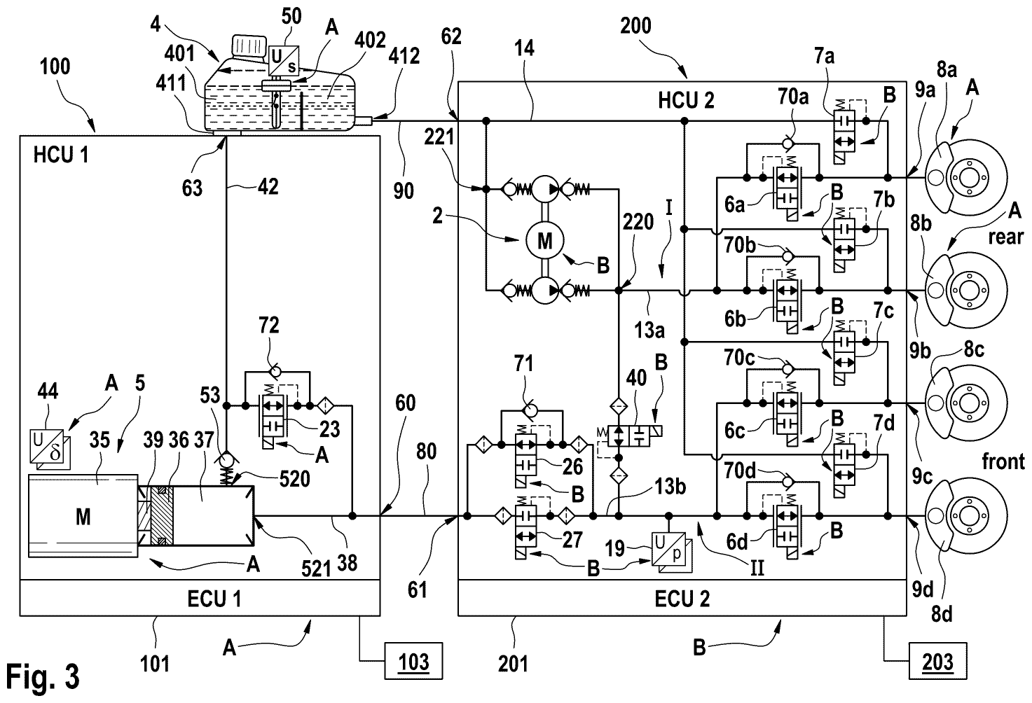

FIG. 3 schematically illustrates a third exemplary embodiment of a brake system. In contrast to the second exemplary embodiment of FIG. 2, a further electrically actuable valve 27 which is of normally closed configuration is provided in the second structural unit 200. This is connected in parallel to the isolation valve 26. The valve 27 is actuated by the second electronic control device 201.

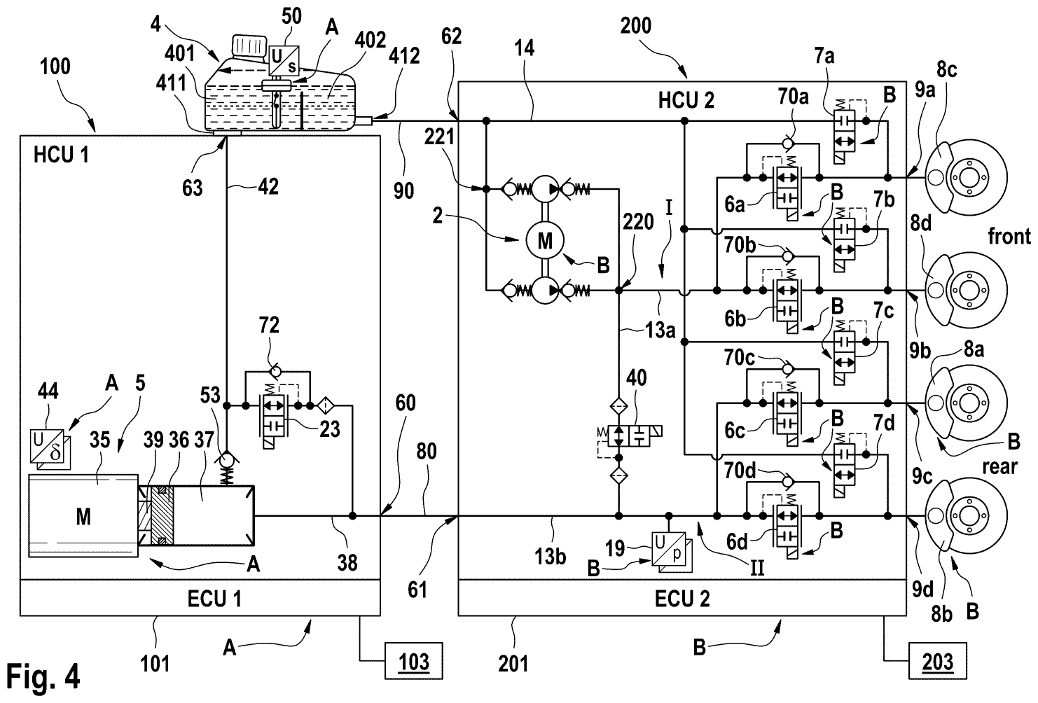

FIG. 4 schematically illustrates a fourth exemplary embodiment of a brake system. In contrast to the brake system of FIG. 1, the isolation valve 26 is omitted. The pressure source 5 is directly connected to the first line section 13a.

However, the saving of the isolation valve 26 leads to several disadvantages. If the first structural unit 100 fails (e.g. due to an electrical fault in the ECU1 or partition A, or due to a leak in the structural unit 100), the pressure source 2 can only build up pressure in the first line section 13a (with the circuit isolation valve 40 closed). The pressure source 5 can only be replenished if inlet valves 6c, 6d without a check valve 70c, 70d (not shown) are used in the second line section 13b.

Advantageously, therefore, the vehicle axles are reversed in this embodiment, i.e. the second line section 13b is connected to the wheel brakes 8a, 8b of the rear axle (rear) and the first line section 13a, which is connected to the pressure source 2, is connected to the wheel brakes 8c, 8d of the front axle.

The electrically actuable parking brakes on the rear wheels (rear) are advantageously activated and actuated by the second electronic control device 201 (characterized by B on the wheel brakes 8a, 8b in FIG. 4).

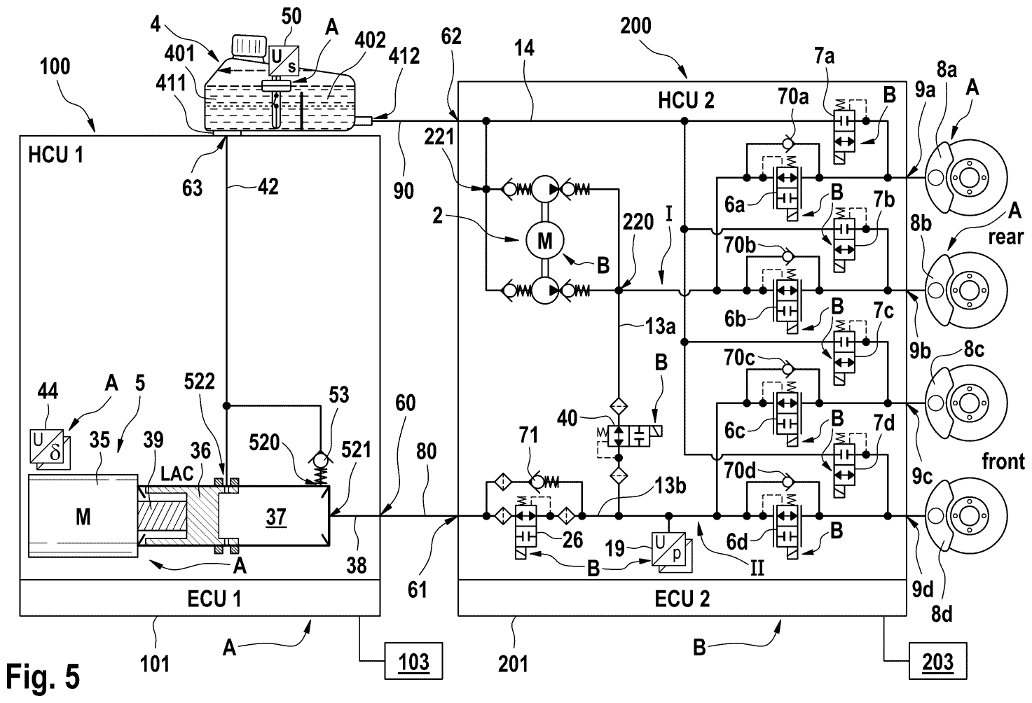

FIG. 5 schematically illustrates a fifth exemplary embodiment of a brake system. In contrast to the brake system in FIG. 2, the isolation valve 23 incl. check valve 72 is omitted. The hydraulic connection with the valve 23, 72 between the line sections 38 and 42 is thus omitted. In exchange, the pressure source 5 additionally comprises a mechanism for atmospheric attachment. According to the example, the cylinder-piston arrangement 5 (linear actuator) is configured with a snifter hole 522.

A corresponding embodiment (omission of the valves 23, 72 and embodiment of the pressure source 5 with a snifter hole 522) is also possible in the brake systems of the exemplary embodiments of FIGS. 1, 3 and 4.

The saving of the isolation valve 23 thus leads to additional complexity in the pressure source 5. The above-described function of the isolation valve 23 to remove additional volume provided by the pressure source 2 has to be taken over by the outlet valves 7a-7d, which is less convenient.

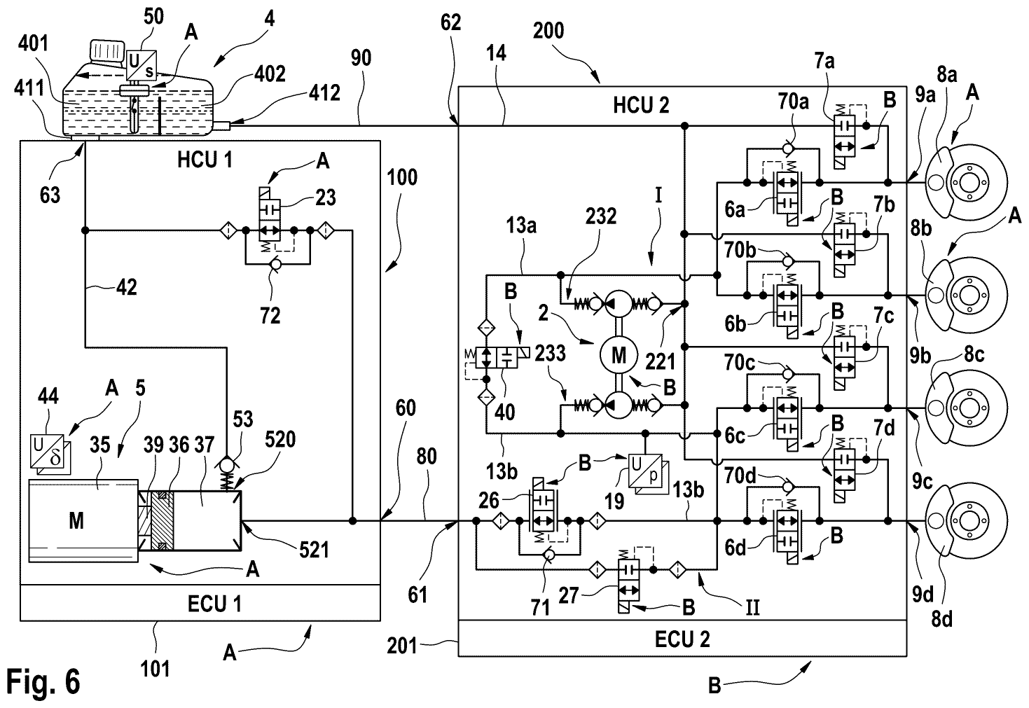

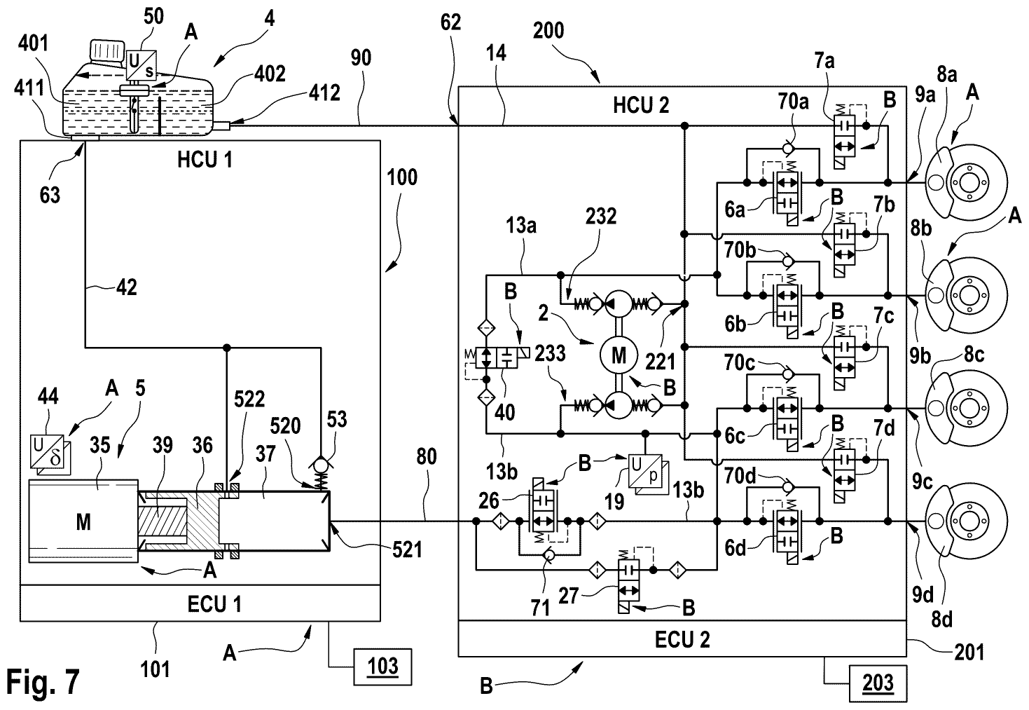

According to further preferred exemplary embodiments of the brake system (see e.g., FIGS. 6 and 7), the second pressure source 2 is of two-circuit configuration, in particular as a two-piston pump. The two suction sides remain connected (suction connection 221) here and are connected to the return line 14. The two pressure sides are not interconnected. One of the pressure sides (pressure connection 232) is connected to the first line section 13a, and the other pressure side (pressure connection 233) is connected to the second line section 13b. This embodiment of the pressure source 2 is possible in all exemplary embodiments described so far. This embodiment has the advantage that, even after failure of the first partition A (e.g., of the first electronic control device 101), a two-circuit operation is possible, i.e. that both line sections 13a and 13b can be pressurized by means of the pressure source 2. A disadvantage is the reduced pressure build-up dynamics in the line section 13a in two-circuit operation. For example, FIGS. 6 and 7 show corresponding embodiments proceeding from the brake systems of FIGS. 3 and 5.

FIG. 8 shows a further exemplary embodiment of a brake system. The differences to the first embodiment of FIG. 1 are described below.

The first structural unit 100 (or valve block HCU1) includes, in addition to the first pressure source 5 and its (replenishing) line 42 with the check valve 53, an isolation valve 26 of normally closed configuration, which is actuated by the first electronic control device 101. The hydraulic connection with the valves 23, 72 between the line sections 38 and 42 is omitted; the pressure source 5 does not comprise any snifter holes. The isolation valve 26 is arranged hydraulically between the pressure source 5 and the line section 13b of the brake supply line 13, namely between the pressure source 5 and the connection 60 of the first structural unit 100.

The second structural unit 200 (or valve block HCU2) includes, in addition to the second pressure source 2 and the inlet and outlet valves 6a-6d, 7a-7d and the circuit isolation valve 40, which are actuated by the second electronic control device 201, an isolation valve 28 of normally open configuration, which is connected in parallel to the pressure source 2, that is to say connects the suction sides of the pressure source 2 to the pressure sides of the pressure source 2 and connects the return line 14 to the line section 13a. A check valve 29 closing in the direction of the pressure medium reservoir 4 (the return line 14) is connected in parallel to the isolation valve 28. The isolation valve 28 is preferably configured as an analog valve. The isolation valve 28 is configured to be double-actuated, i.e. it comprises two separate, electrically independent actuating coils, wherein one coil is actuated by the first electronic control device 101 (partition A) and the other coil is actuated by the second electronic control device 201 (partition B).

The division of the brake systems according to the example into two structural units offers the advantage that both structural units are smaller and lighter, and therefore easier to handle, compared to a realization in just one structural unit. They can also be manufactured more easily on existing production equipment. When divided into two structural units, each hydraulic connection between these structural units will result in additional complexity and costs. It is therefore advantageous to keep the number of hydraulic connections as small as possible. It is advantageous, moreover, to separate the various functions of hydraulic connections as clearly as possible. Connections, via which pressure medium is sucked in, should have as little hydraulic resistance as possible and therefore as great a diameter as possible. For this purpose, it is advantageous if it is achieved that such connections do not have to be pressure-resistant. Conversely, pressure-bearing connections should not have a suction function.

The choice and arrangement of electrically actuable valves, electronic partitioning and, in particular, the allocation between electrically actuable valves and electronic control devices enable these advantageous properties of the hydraulic connections of the two structural units. In addition to the pressure-free or non-pressure-resistant connections to the pressure medium reservoir, it makes it possible for the two structural units to only require a pressure-resistant connection that hydraulically connects them to each other. The at least four connections between the second structural unit 200 (or the wheel connections (9a-9d)) and the wheel brakes 8a-8d are likewise pressure-resistant connections.

1-15. (canceled)

16. A brake system for a motor vehicle having at least four hydraulically actuable wheel brakes, said brake system comprising:
a first structural unit in which a first electrically actuable pressure source is arranged;
a second structural unit in which a second electrically actuable pressure source, an electrically actuable inlet valve per wheel brake, and an electrically actuable outlet valve per wheel brake are arranged; and
a pressure medium reservoir;
wherein the first pressure source and the second pressure source are connected to a brake supply line to which the at least four inlet valves are connected; and
wherein the first structural unit and the second structural unit are connected to each other by at most one pressure-resistant hydraulic connecting element.

17. The brake system as claimed claim 16, wherein the first pressure source is connected to the brake supply line via an electrically actuable first isolation valve, and wherein the first isolation valve is arranged in the second structural unit.

18. The brake system as claimed in claim 17, wherein the first pressure source is connected to the pressure medium reservoir via an electrically actuable second isolation valve, and wherein the second isolation valve is arranged in the first structural unit.

19. The brake system as claimed in claim 16, further comprising an electrically actuable, normally open, circuit isolation valve arranged in the brake supply line such that, with the circuit isolation valve closed, the brake supply line is hydraulically separated into a first line section and a second line section, wherein the first line section is hydraulically connected to the second pressure source and at least two of the at least four inlet valves, and the second line section is hydraulically connected to the first pressure source and the others of the at least four inlet valves, and wherein the circuit isolation valve is arranged in the second structural unit.

20. The brake system as claimed in claim 16, wherein the first structural unit includes at least one first hydraulic connection for connecting to the pressure medium reservoir and a second hydraulic connection for connecting to the second structural unit, and wherein the second hydraulic connection is connected to the pressure-resistant hydraulic connecting element.

21. The brake system as claimed in claim 16, wherein the second structural unit includes at least four hydraulic wheel connections for connecting to the wheel brakes, a first hydraulic connection for connection to the pressure medium reservoir and a second hydraulic connection for connection to the first structural unit, wherein the second hydraulic connection is connected to the pressure-resistant hydraulic connecting element.

22. The brake system as claimed in claim 21, wherein the second structural unit does not include a further hydraulic connection.

23. The brake system as claimed in claim 21, further comprising a first hydraulic connection of the first structural unit and a first hydraulic connection of the second structural unit, which are connected to different chambers of the pressure medium reservoir.

24. The brake system as claimed in claim 16, wherein the second pressure source is connected to the pressure medium reservoir on the suction side without intermediate switching of an electrically actuable valve, in particular via the first hydraulic connection of the second structural unit and a hydraulic connecting line connected to the first hydraulic connection.

25. The brake system as claimed in claim 16, wherein the first and second pressure sources are the only pressure sources for building up a brake pressure for actuating the wheel brakes.

26. The brake system as claimed in claim 16, wherein the first structural unit includes a first electronic control device which controls the first pressure source.

27. The brake system as claimed in claim 18, wherein the first structural unit includes a first electronic control device which controls the first pressure source.

28. The brake system as claimed in claim 27, wherein the second isolation valve is actuated by the first electronic control device.

29. The brake system as claimed in claim 16, wherein the second structural unit includes a second electronic control device which actuates the second pressure source and the inlet and outlet valves.

30. The brake system as claimed in claim 19, wherein the second structural unit includes a second electronic control device which actuates the second pressure source and the inlet and outlet valves.

31. The brake system as claimed in claim 30, wherein the circuit isolation valve is actuated by the second electronic control device.

32. The brake system as claimed in claim 17, wherein the second structural unit includes a second electronic control device which actuates the second pressure source, the inlet and outlet valves, and the first isolation valve.
